(19) United States
(12) Patent Application Publication
(10) Pub. No.: US 2014/0244736 A1
(43) Pub. Date: Aug. 28, 2014

(54) File Sharing in a Social Network

(71) Applicant: Artases OIKONOMIDIS, Moscow (RU)

(72) Inventor: Artases OIKONOMIDIS, Moscow (RU)

(21) Appl. No.: 13/774,251

(22) Filed: Feb. 22, 2013

(51) Int. Cl. H04L 29/08

(52) U.S. Cl. CPC H04L 29/08117
USPC 709/204; 709/219

(57) ABSTRACT

Technical features described herein can be used to construct various embodiments of a file share server implemented over a computer network to serve a social network of users. In one approach, files are uploaded to the file share server by members of a social network based on time and location of creation and related to a particular real world event, either at a physical location or online. Members of a social network then access the file share server, search for the real world event, and retrieve files as desired from the file share server. Secondary files may be created by users that describe other files such as visual files, and may be annotations of the visual files, or aural descriptions of the files to which they relate.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### TECHNICAL FIELD

The present invention relates broadly to computer networks. Specifically, the present invention relates to file sharing over a computer network. More specifically, the present invention relates to file sharing in a social network utilizing a computer network.

### BACKGROUND

Social networks have skyrocketed in popularity among computer users because of their ease of use and ability to provide exclusive relationships among groups of individuals. Implemented on computer networks such as the Internet, social networks allow people to share details of their lives, such as activities and contact lists of friends and colleagues. In social networks, individuals can inspect contacts of people they claim as contacts, and thus expand their own social circles. For example, a user can inspect profiles of individuals listed as contacts by the user's contact, and introduce himself or herself to the secondary contact and establish a direct relationship with someone new. Many people post profile information on their social network, inviting contact from new people. Such profile information typically includes age, gender, occupation, hobbies, family members, and other items people wish to share with others. Because social networks provide an effective way to meet new people who have similar interests or professional backgrounds, social networks have become an important tool for expanding business contacts and making new friendships. They also have become effective tools for disseminating news and opinions over a broad audience. For example, in a social network where an individual may have hundreds of contacts listed, the audience that can be reached through a social network can grow to thousands over just two or three degrees of separation between users.

Social networks offer safety to individual users as there generally is permission that must be granted by an individual in order to become a contact of that individual. This is very important from a safety perspective, as well as a business perspective. As people typically exercise some degree of discretion in real-life associations with other individuals, social networks also provide this permissive aspect that protects people from associating with individuals that a user would choose not to associate with online or in real life

There is a heartfelt need for improved file sharing among members of a social network.

### SUMMARY

In one aspect, the present invention provides of method of sharing files over a computer network by providing a file share server, the file share server accessible to a plurality of users over a computer network, the file share server associating a plurality of files by their relation to a real-world event and time; connecting to a plurality of users and receiving files from users in the plurality; determining a time and place at which a received file was created; storing files that meet a requirement for time and place; and displaying stored files to users in the plurality. In an embodiment, files in the plurality are photograph files. In an embodiment, files in the plurality are music files. In an embodiment, files in the plurality are audio files containing spoken narrations of photographs. In an embodiment, the method further comprises the act of allowing users to search the file server for files related to a specific event. In an embodiment, the method further comprises the act of rejecting files that do not satisfy time and place requirements. In an embodiment, the requirement for time and place is met by reading a received file for timestamp information. In an embodiment, the requirement for time and place is met by reading a GPS location indication from the received file. In an embodiment, users access the file share server from a social network. In an embodiment, users access the file share server by entering information displayed on a ticket that allows entry into an event. In an embodiment, users access the file share server by entering a name that is associated with a guest list for a specific event. In an embodiment, users access the file share server by entering a password distributed at an event. In an embodiment, files stored on the file share server are only accessible for a specified duration of time.

In another embodiment, the present invention provides a computer-usable medium for file sharing over a social network implemented over a computer network, the computer-usable medium embodying computer program code, the computer program code comprising computer executable instructions configured for providing a file share server, the file share server accessible to a plurality of users associated with each other in a social network implemented across a computer network, the file share server associating a plurality of files by their relation to a real-world event and time; connecting to a plurality of users and receiving files from users in the plurality; determining a time and place at which a received file was created; storing files that meet a requirement for time and place; and displaying stored files to users in the plurality. In an embodiment, files in the plurality are photograph files. In an embodiment, files in the plurality are music files. In an embodiment, files in the plurality are audio files containing spoken narrations of photographs.

In yet another aspect, the present invention provides a computer-usable medium for file sharing over a social network implemented over a computer network, the computer-usable medium embodying computer program code, the computer program code comprising computer executable instructions configured for providing a file share server, the file share server accessible to a plurality of users associated with each other in a social network implemented across a computer network, the file share server associating a plurality of files by their relation to a real-world event; connecting to a plurality of users and receiving files from users in the plurality; reading a code from the received files; storing files the received files in a searchable database that organizes files by event, date and time; and displaying stored files to users in the plurality upon receiving a search query indicating an event. In an embodiment, the requirement for time and place is met by reading a received file for timestamp information. In an embodiment, the requirement for time and place is met by reading a received file for a GPS location indication. In an embodiment, users access the file share server from a social network. In an embodiment, users access the file share server by entering information displayed on a ticket that allows entry into an event. In an embodiment, users access the file share server by entering a name that is associated with a guest list for a specific event. In an embodiment, users access the file share server by entering a password distributed at an event. In an embodiment, files stored on the file share server are only accessible for a specified duration of time.

Many other features and advantages of the present invention will become apparent to those skilled in the art upon reading the following detailed description, when considered in conjunction with the accompanying illustrations.

### DESCRIPTION OF THE DRAWINGS

FIG. 1 illustrates a block diagram illustrating a file sharing system provided in a social network according to an embodiment;

FIG. 2A illustrates a flow diagram of an exemplary sequence of acts performed in accordance with an embodiment;

FIG. 2B illustrates the flow diagram of FIG. 2A with additional steps included according to another embodiment;

FIG. 3 illustrates a flow diagram of an alternative exemplary sequence of acts performed in accordance with an alternative embodiment;

FIGS. 4-5 illustrate flow diagrams of alternative exemplary sequences of acts performed in accordance with file sharing algorithms of an embodiment;

FIG. 6 illustrates in state diagram format operating states of the file sharing system of one or more embodiments at different stages of execution;

FIG. 7 illustrates a block diagram of a social network implemented across a computer network in accordance with an embodiment;

FIG. 8 illustrates a block diagram of functional components included in devices that are used by members of the social network in the computer network of FIG. 7 in accordance with an embodiment;

FIG. 9 illustrates exemplary modules of the file sharing system, implemented as a client and server according to one embodiment; and

FIG. 10 illustrates one screen shot of an exemplary user interface for a file sharing system according to one embodiment that enables a user to view, upload, and overlay event files, and initiate requests to join event file shares.

### DETAILED DESCRIPTION OF THE PREFERRED EMBODIMENTS

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Technical features described in this application can be used to construct various embodiments of file sharing in a social network.

In the following description, for purposes of explanation and not limitation, specific details are set forth, such as particular preferred embodiments, procedures, techniques, etc. in order to provide a thorough understanding of the present invention. However, it will be apparent to one skilled in the art that the present invention may be practiced in other embodiments that depart from these specific details.

Reference will now be made to the drawings in which the various elements of embodiments will be given numerical designations and in which embodiments will be discussed so as to enable one skilled in the art to make and use the invention.

Specific reference to components, process steps, and other elements are not intended to be limiting. Further, it is understood that like parts bear the same reference numerals, when referring to alternate Figures. It will be further noted that the Figures are schematic and provided for guidance to the skilled reader and are not necessarily drawn to scale. Rather, the various drawing scales, aspect ratios, and numbers of components shown in the Figures may be purposely distorted to make certain features or relationships easier to understand.

Technical features described herein can be used to construct various embodiments of a social network implemented across a computer network that allows a plurality of users to share files related to a particular real-world event. As referred to herein, a real-world event is an event that members of a social network attend, either in person or online. For example, a real-world event can be a wedding, a concert, a play, a sporting event, or any event where people congregate in the same physical location. A real-world event can also include online events such as webcasts, webinars, classes held in distance learning applications (online schools, for example), an entertainment event held online, such as the showing of a movie or concert, speech, news webcast, or other audio or visual event that is distributed to users across a computer network.

In one approach, technical features described herein can be used to construct a method of sharing files over a computer network. The method can comprise providing a file share server, the file share server accessible to a plurality of users over a computer network, the file share server associating a plurality of files by a real-world event and time; connecting to a plurality of users and receiving files from users in the plurality; determining a time and place at which a received file was created; storing files that meet a requirement for time and place; and sending stored files to users in the plurality.

In another approach, technical features described herein can be used to construct an apparatus for administering a file share server in a social network, wherein the apparatus comprises: at least one processor; at least one data bus coupled to the processor; a computer-usable medium embodying computer program code, the computer-usable medium being coupled to the data bus; and the computer program code comprising instructions executable by the processor and configured for: a. providing a file share server, the file share server accessible to a plurality of users over a computer network, the file share server associating a plurality of files to a real-world event; b. connecting to a plurality of users and receiving files from users in the plurality; c. determining a passcode related to a real world event; d. storing files that meet a requirement for time and place; and e. sending stored files to users in the plurality. The files may be stored for a predetermined time duration determined by a user and received by the file share server at the time the file is uploaded to the file share server. The files may be stored for a predetermined time duration determined for all files related to a particular event.

Files, as referred to herein, generally are digital assets such as photographs, videos, audio files, and the like, which are capable of being stored digitally and reproduced on remote devices when disseminated across a computer network. User devices, as referred to herein, generally are computing devices that communicate with a server across a computer network. User devices may be client devices such as any computing device capable of receiving and sending file sharing information over an electronic network. Such user devices may include personal computers, multiprocessor systems, micro-processor based or programmable consumer electronics. Examples include desktop computers, laptop computers, tabular computers, notebook computers, cell phones, smart phones, display pagers, handheld or other wearable devices and the like. User devices may be web-enabled client devices that can communicate over the web and include a browser application that is configured to receive and transmit web pages, web messages and other web information. The browser application may be configured to send, receive and display text, graphics, multimedia by means of a network protocol such as but not limited to Hypertext Transfer Protocol (HTTP) and/or wireless application protocol (WAP).

A social network, as referred to herein, refers generally to associations between users communicating over a computer network. Social networks, as referred to herein, allow users to control the associations between themselves and other users such that access to an individual user's files is granted by admission to the social network by members of the social network.

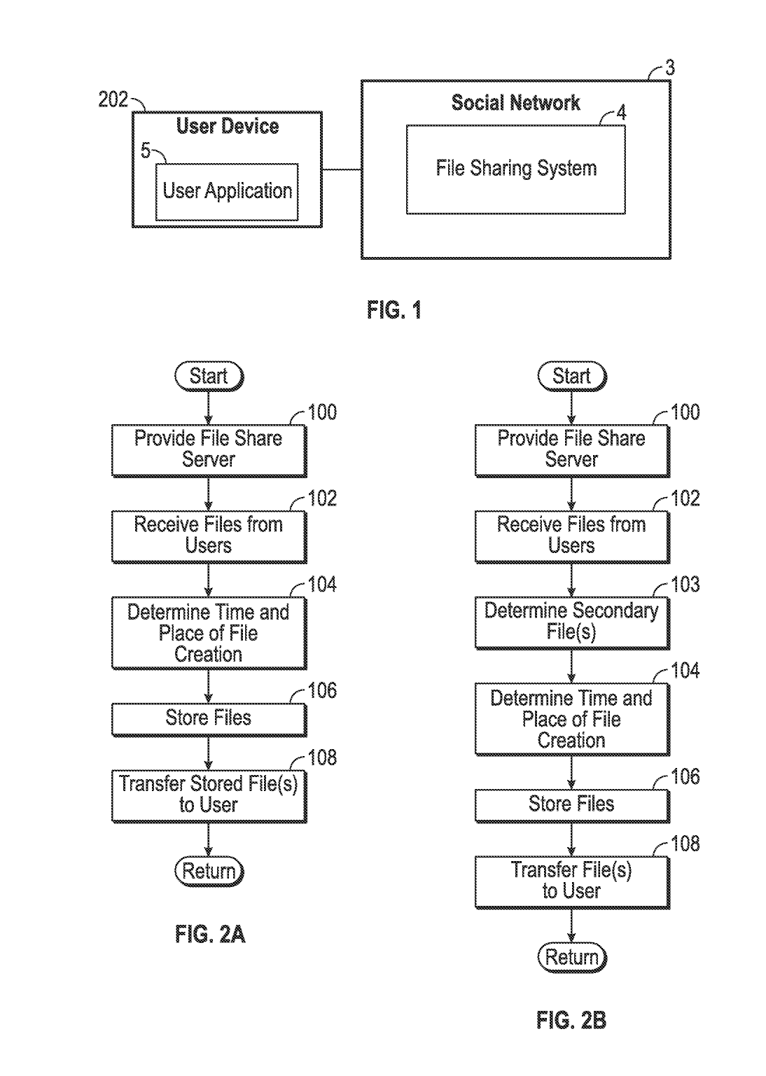

Referring now to the accompanying drawings and, in particular FIG. 1, which illustrates a block diagram outlining a file sharing system provided in a social network according to an embodiment, As a general overview, user application 5 operates in a user device 202. User application 5 in conjunction with social network 3 enable a user to perform social network activities over an electronic network. A file sharing system 4 is provided in social network 3 that enables the user, via user application 5, to share particular files associated with a particular real-world event with other users. Social network 3 and file sharing system 4 may be practiced in many different environments. By way of example, social network 3 and file sharing system 4 may be implemented as at least one network server site, as a cloud service or by other techniques. For example, network service site functions may be provided by a cloud computing facility in which the services and functions attributed herein to the file share server are delivered as a service over the internet rather than by a specific server or cluster of servers. The electronic network over which the social network, including the file sharing activities, are performed may be the Internet, but equally can be any one of, combination of, or interconnection of, but not restricted to: a local area network (LAN); a wide area network (WAN): a home network; and a wireless network.

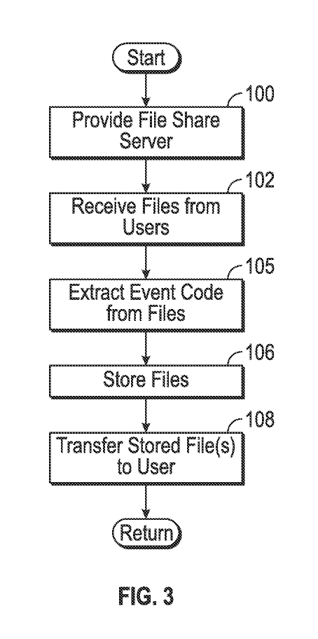

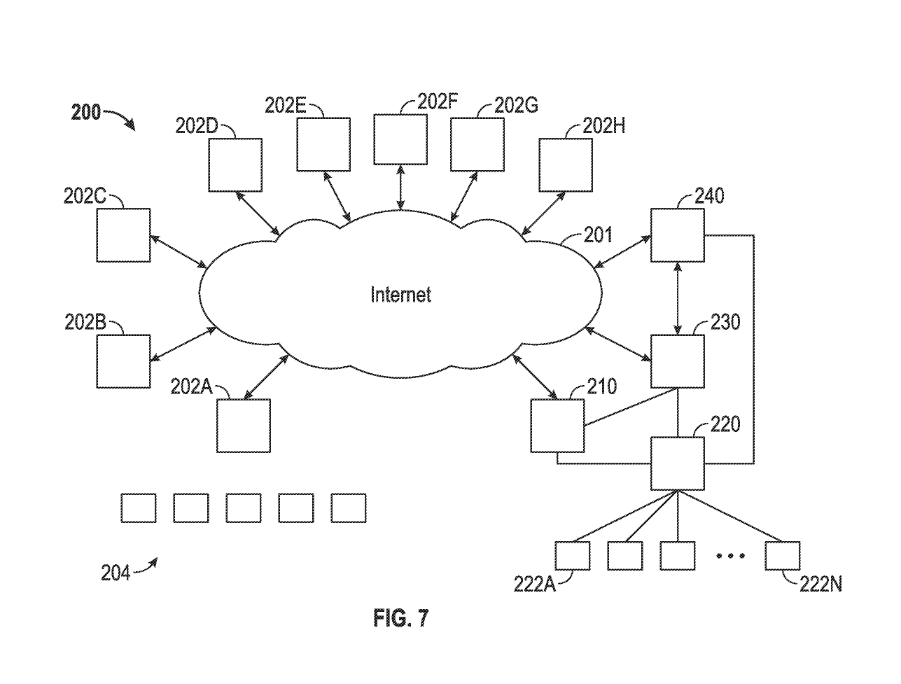

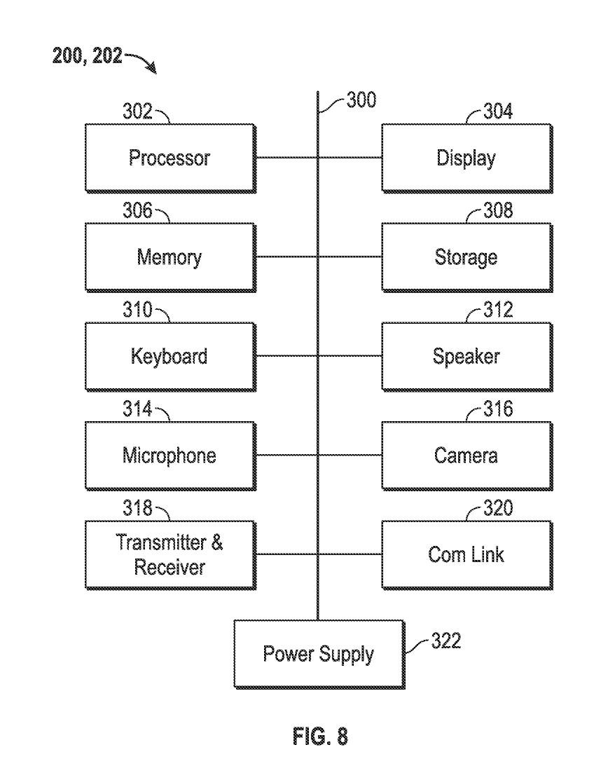

FIGS. 2A-3 illustrate sequences of acts performed in accordance with embodiments. Explanations of these sequences of acts are made with reference to hardware illustrated in block diagram form in FIGS. 7-8. These methods are also embodied in software that is executed both on user devices and a file share server, and implement a social network that functions across a computer network of clients and at least one server computing device, as will be explained in more detail below.

Referring generally to FIG. 2A, there is shown in flow diagram form a sequence of acts performed in accordance with an embodiment. Beginning at act 100, file share system 4 of FIG. 1 is implemented as a file share server 200 (see FIGS. 7 & 8) by executing computer code on a computing device. File share server 200 is in communication with multiple user devices 202 across a computer network, telecommunications network, or a combination thereof. At act 102, file share server 200 receives files from members of a social network utilizing user devices 202. These files are then examined by file share server 200 at act 104 to determine the time and place of the file's creation. This allows file share server 200 to filter out and reject unrelated or undesirable files and only store files associated with a real-world event. Other data criteria can also be evaluated, such as names on a guest list of an event, GPS location data at the time a file was created, information appearing on a ticket that admits a person to a real world event, or a password or event code disseminated at an event, and the like, to determine event description and eligibility to upload files to file server 200. Also, in an optional feature, a time duration may be specified during which a file is available for download to other users. This time duration may be specified by the user during upload of file, or it may be set as a policy for the event to which uploaded files relate. Also as another optional feature, a user can enter GPS data, in particular, GPS location and time data for the real-world event via the user device and associate this with particular stored files to be shared.

At act 106, files meeting predetermined criteria such as time and place are stored in a searchable, relational database on file share server 200. In various embodiments, files stored in the database contain photographs, video, audio, or combinations thereof taken at a real world event, but may also include such secondary files created after the occurrence of a real world event, such as voice narrations of files created at the real world event. For online real world events, files may contain static screen shots appearing on a user device, or video and/or audio likewise captured on a user device during an online event. Visual files that are neither photographs nor video, yet graphical in nature, such as visual aids displayed online, may also be captured as files. Also, as described above, secondary files may also be created by users if they relate to the online event. Such secondary files may be voice narration, creation of new photograph, text files such as written notes, visual or video files, or manipulation of existing audio, visual, video or photograph files. This is a particularly useful aspect of one or more embodiments for distance learning applications, where students can form online study groups and collaborate on exercises, projects or test preparation.

At act 108, files stored on file share server 200 are communicated to user device 202. Typically, this occurs when a member of a social network operates a user device 202 to access file share server 200, search for files related to a particular real world event, and retrieve them to his or her device. Typically, a user will enter a description of the event or the date on which it occurred, or his or her name, or information on an event ticket or the event code or password described above. For example, a user may wish to review all photographs taken at a San Francisco Giants baseball game. The user can enter his or her ticket number, and be shown a menu of files uploaded by members of his or her social network who also attended the game. This allows multiple views of a particular moment in the game, or of members of the social network themselves, and the like. Event promoters can use embodiments of the present invention to generate or increase interest in a particular event, hold contests for files among members of the social network, and award prizes, donate to charities, or provide upgrades based on participation by members of social networks. Also, promoters of events may create individual social networks based on particular events, to promote social interaction among attendees and generate additional interest in the promoter's future events through operation of the social network and file share server 200. Advertisers appearing on the social network may be included as a service to members of the social network, or revenue generation for the operator of file share server 200 or the event promoter.

Directing attention to FIG. 2B, the acts of FIG. 2A and additional acts that may be practiced in accordance with alternative embodiments of the present invention are shown in flow diagram form. In addition to acts 100-108 from FIG. 2A, a secondary file indicator is determined at act 103. A secondary file is typically a file that describes another file. For example, an audio file in which a member of a social network provides a spoken narration or comment regarding another file, such as a photograph, music, video, or other file associated with an event. Secondary files are especially useful for online events. For example, a secondary file can be written notes related to an online course or presentation, or visual aids presented during such an event, but with an overlay file in which a member of a social network (or online class) has marked up a visual aid presented during an online class. In this case, the visual aid can be captured and uploaded to file share server 200 as a first file, and the overlay or notes can be uploaded as a secondary file relating to the first file.

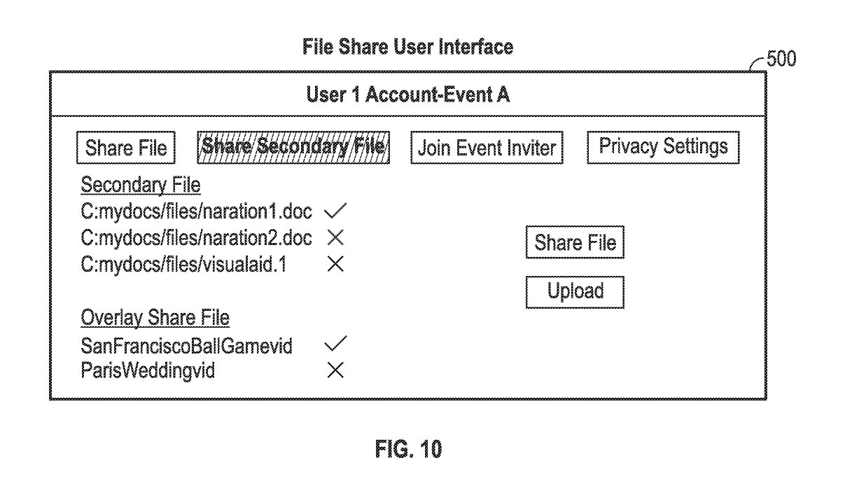

FIG. 10 illustrates one screen shot of an exemplary user interface 500 rendered on the user device that enables a user to view and interact with the file sharing system according to one embodiment. User interface 500 can be manipulated on the user device by the user to provide a variety of screen views in response to user selection that enable the user to share files, upload event files, overlay event files with secondary files, and initiate requests to join event file shares. In the non-limiting example shown in FIG. 10, the screen shot shows the user interface in a “share secondary file” user selected view that enables a user to overlay event files with secondary files.

In one embodiment, user interface 500 is implemented as an interactive Web page that is provided by social network 3 to a web-enabled client device for display through a Web browser. In one example, user application 5 is implemented via the web browser and responds to instructions, such as HTML5 instructions, from the social network 3.

Directing attention to FIG. 3, an alternative sequence of acts performed in accordance with an embodiment of the file sharing system is illustrated in flow diagram form. FIG. 3 also follows the flow illustrated in FIG. 2A, but instead of reading GPS and time indication to determine event description at act 104, the received file is checked for an event code included in the file at act 105. The event code can be a numeric indicator, such as a ticket number, or passcode disseminated to attendees of the event. For example, when a ticket is obtained, a passcode can be sent via text message to an attendee's phone. In another example, the passcode can be displayed at the event, such as on the scoreboard at a San Francisco Giants game.

The software system has a file sharing system application module which is stored in system storage/memory. The software system can include a kernel or operating system and a shell or interface. One or more application programs or modules, such as the file sharing system application module, may be “loaded” (i.e. transferred from storage into memory for execution by the processor). The system receives user commands and data through user interface; these inputs may then be acted upon by the file share server, in accordance with instructions from operating module and/or application module.

Note that the term “module” as used herein may refer to a collection of routines and data structures that perform a particular task or implements a particular abstract data type. Modules may be composed of two parts: 1) an interface that lists the constants, data types, variable, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task. In other examples, at least part of the modules may be implemented by hard-wired logic or other circuitry.

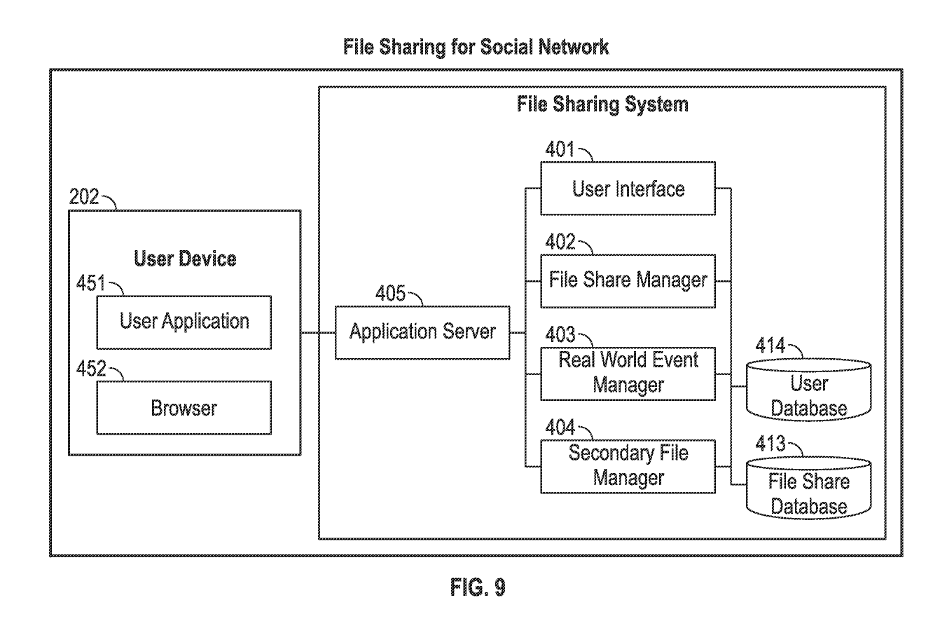

FIG. 9 illustrates exemplary modules of the file sharing system, implemented as a client and server according to one embodiment. Application server module 405 receives instructions from the user device and in response invokes the appropriate file sharing system module. The file sharing system modules may include user interface module 401, file share manager 402, real world event manager 403, and secondary file manager 404, which are configured to perform the respective user interface, file sharing, real-world event retrieval and file association, and secondary file functionality and operations described herein.

As indicated hereinbefore, the user device may be a web-enabled user device in which the user application 451 is a web application written standard programming languages, such as but not limited HTML5, and executed by a browser 452 that runs in user device 4. In one non-limiting example, browser 452 works in conjunction with a client-side scripting engine that executes programming language such as but not limited JAVASCRIPT® from ORACLE CORPORATION of Redwood Shores, Calif., or the like. In one embodiment, browser 452 is configured to use Ajax (asynchronous JavaScript and XML or JSON) web development techniques that are used to create interactive web applications.

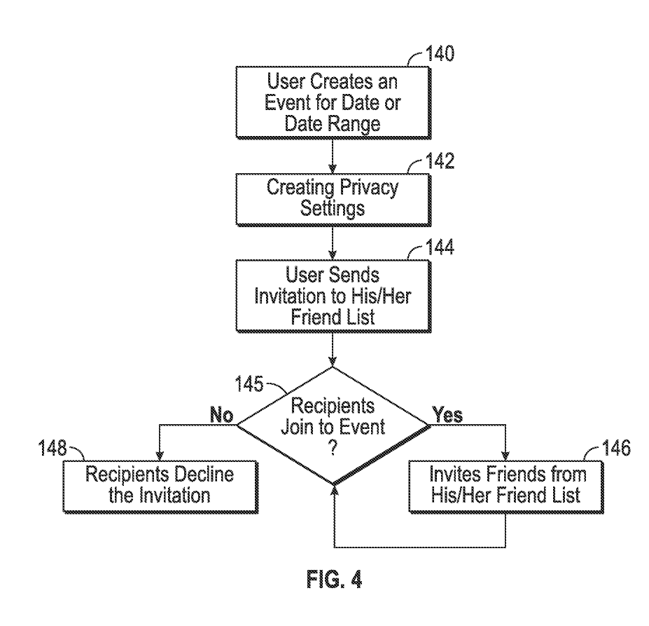

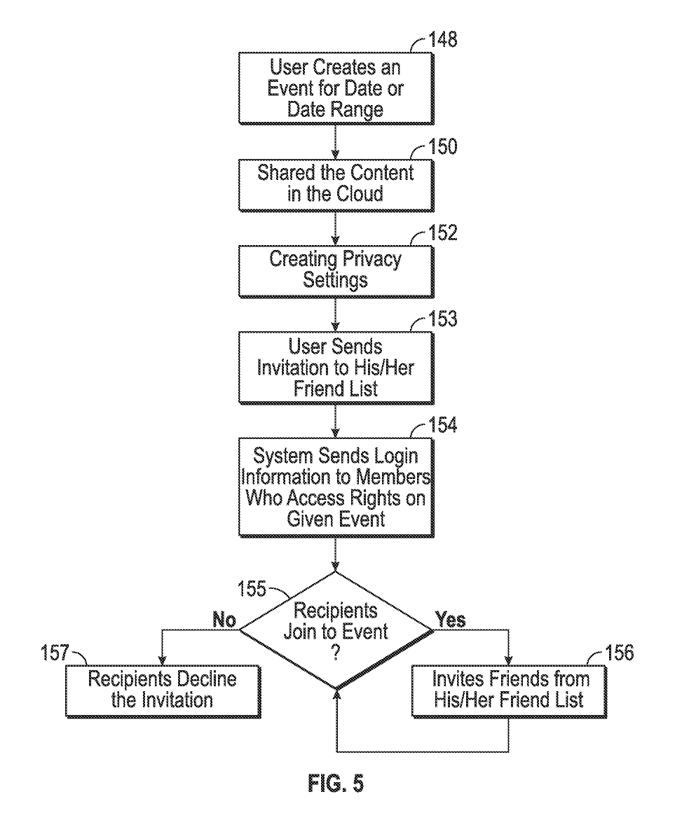

Operation of the sharing process of the file sharing system 4 according to one example as embodied in a cloud computing environment may proceed as shown in flowchart FIGS. 4-6. Directing attention to FIG. 4, the user creates an event for date or a date range at act 140. Directing attention to FIG. 4, at act 140 a user creates and event for a specific date or date range. Control transitions to act 142, where privacy settings are created. This controls access to files and adds exclusivity to a user's online digital assets. At act 144, the user sends invitations to friends on a list maintained by the user. At decision step 145, recipients either join or decline the invitation, and invitation occurs until all invitations are answered or timed out or declined (act 147), or a user is satisfied with manually inviting contacts to join an event. The process then terminates and executes again as selected by a user. Alternatively, directing attention to FIG. 5, at act 148, the user creates an event for a specific date or date range, shares the content in a cloud environment at act 150, which is particularly useful for storage of files, as well as handling of internet traffic, protection of identity theft, and many other advantages over non-cloud environments. Privacy settings are created at act 152, and then at act 153 the user sends invitations to members of a list of friends or other contacts, and a system at act 154 sends login information to members who have access rights to a certain event. At decision box 155, recipients either join to the event and at act 156 invite contacts from their own friend/contact list. Otherwise at act 157, recipients decline the invitation and control returns.

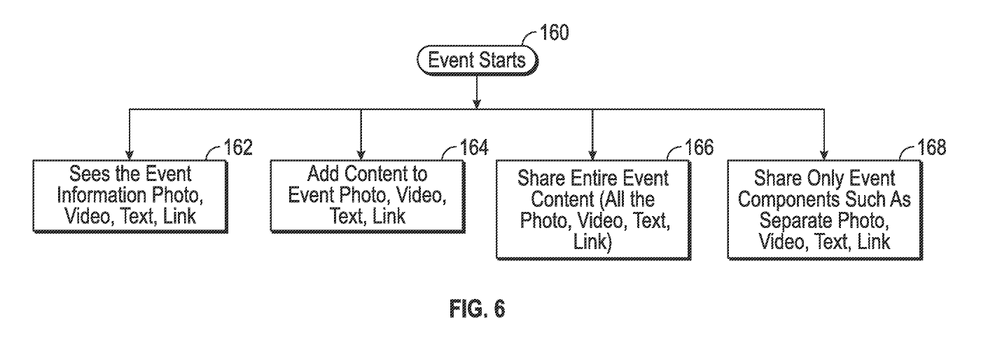

Directing attention to FIG. 6, at act 160, an event begins. A user, who has joined the event as described above, has several possible states. Among them are state 162, where the user sees the events information, such as through shared digital assets such as photos, video, text, links, audio, and the like. At state 162, an online experience of the event occurs to some degree by the user. At state 164, the user can add content to the event, in the forms just described for state 162. At state 166, the user can share the event's content uploaded thus far and described in states 162, 164. At state 168, a filtering aspect is presented to the user, and the user can share the event content if certain criteria are met, such as controlling what uploaded assets a user does not wish to share.

Directing attention to FIG. 7, a relational illustration in block diagram form of file server 200 and a plurality of user devices and equipment 202 are shown. File server 200 refers broadly to a configuration of equipment that as a system functions to collect files from users and to distribute files to users. In an embodiment, file server 200 may include multiple servers, each of which has functionality that is well-known by those skilled in the art. For example, file servers 210, 220,230 and 240 are servers operating as file server 200. Server 210 is a streaming media server. Server 220 is a database server, handing individual data storage systems 222. In an embodiment, file server 200 includes a relational database that stores files with file descriptors indicating specific events, geographical locations, and times (not shown). File server 230 is a web server that controls communication with devices and equipment 202 over Internet 201. File server 240 is an e-Commerce server, which handles financial transactions with customers for file server 200. User devices and equipment 202 are shown in various configurations in FIG. 4, and while lines are drawn between user devices 202, it is to be understood that there is no requirement of direct, physical links between file share server 200 and user devices 202. Typically, communication between file share server 200 and user devices 202 is implemented over a computer network utilizing a telecommunications network, such as a public telephone network 202A, in communication with portable devices 204, which are devices such as cell phones, smart phones, tablet computers, notebook computers, and the like. Thus, users can be located at geographically diverse locations, such as different cities, states, and countries around the world. Also as shown, user devices 202 can be a large number of devices, indicated by user device 202N. As shown, file share server 200 and user devices 202 are associated in a traditional client-server relationship. File share server 200 acts as a coordinator of files received from and distributed to user devices 202 that are operated by individual users who form an exclusive group that embodies a social network. Other user devices can be desktop, laptop, workstation or server configurations such as file server 200 and operated by other entities, such as operating at well-known commercial websites, or simply access points providing Internet connectivity to other user devices. Non-limiting example technologies for implementing file server and associated services are as follows: IIS 7.5, FMS 4.0, Node JS Server for the webserver; ASP.NET 4, Flash/Flex, Action Script 3.0 for Server-side Scripting Engine; MVC 2.0 for the Software Architect System, MS SQL Server 2008 R2 for the database and WCF for webservices.

FIG. 8 illustrates in block diagram the major components of a computing device embodying file share server 200 according to one embodiment. The computing device of FIG. 8 is also one example of a computing device of one or more user devices 202. Bus 300 interconnects various functional components that combine to provide the functionality of a computing device. Processor 302 executes instructions loaded into memory 306 from storage 308. Display 304 is typically a screen upon which visual items are displayed to a user, such as text, video, photographs, and the like. Display 304 can also include a touch screen, and serve as an input device as well as a display. Memory 306 typically holds a file temporarily until it is either deleted, or stored in storage 308 or sent to another computing device. Keyboard 310 allows a user to type alphanumeric input to processor 302, but pointing devices such as a mouse or touch pad can also be utilized. Speaker 312 functions to provide an audio output to a user, such as music, ambient sound recorded at an event, audio overlays in which a human provides a spoken description of a file, and the like. Such audio can also be recorded by microphone 314 and placed in memory 306 and/or storage 308. Camera 316 may be included to capture video and photographs, which are placed in memory 306 or storage 308. Connection to a network, such as a computer network or telecommunications network can be via radio, utilizing transmitter and receiver module 318 and an associated antenna, or through a wired connection managed by communication link 320. Finally, power supply 322 can be either a battery, in the case of portable computing devices, or an alternating current supply such as used to power a stationary computing device such as a desktop computer or server farm.

It is to be understood that the described embodiments of the invention are illustrative only and that modifications thereof may occur to those skilled in the art. Accordingly, this invention is not to be regarded as limited to the embodiments disclosed, but is to be limited only as defined by the appended claims herein.

What is claimed is:

1. A method of sharing files over a computer network, comprising:
a. providing a file share server, the file share server accessible to a plurality of users over a computer network, the file share server associating a plurality of files by a real-world event and time;
b. connecting to a plurality of users and receiving files from users in the plurality;
c. determining a time and place at which a received file was created;
d. storing files that meet a requirement for time and place; and
e. sending stored files to users in the plurality.

2. The method of claim 1, wherein files in the plurality are visual files.

3. The method of claim 1, wherein files in the plurality are audio files.

4. The method of claim 1, wherein files in the plurality are audio files containing spoken narrations of photographs.

5. The method of claim 1, further comprising the act of allowing users to search the file server for files related to a specific event.

6. The method of claim 1, further comprising the act of rejecting files that do not satisfy time and place requirements.

7. The method of claim 1, wherein the requirement for time and place is met by reading a received file for timestamp information.

8. The method of claim 1, wherein the requirement for time and place is met by reading a received file for a GPS location indication.

9. The method of claim 1, wherein users access the file share server from a social network.

10. The method of claim 1, wherein users access the file share server by entering information displayed on a ticket that allows entry into an event.

11. The method of claim 1, wherein users access the file share server by entering a name that is associated with a guest list for a specific event.

12. The method of claim 1, wherein users access the file share server by entering a password distributed at an event.

13. The method of claim 1, wherein files stored on the file share server are only accessible for a specified duration of time.

14. A computer-usable medium for administering a file share server in a social network implemented on a computer network, embodying computer program code, the computer program code comprising computer executable instructions configured for:
a. providing a file share server, the file share server accessible to a plurality of users over a computer network, the file share server associating a plurality of files to a real-world event;
b. connecting to a plurality of users and receiving files from users in the plurality;
c. determining a time and location related to a real world event;
d. determining a secondary file indicator located within a received file;
e. storing files that meet time and location criteria for a real world event, including relations between secondary files and other files; and
f. sending stored files to users in the plurality.

15. The medium of claim 14, wherein the secondary file describes another file.

16. The medium of claim 15, wherein the secondary file is an annotation of a visual aid presented in an online class.

17. The medium of claim 15, wherein the secondary class is a text file containing notes taken during the presentation of an online class.

18. A computer-usable medium for administering a file share server in a social network implemented on a computer network, embodying computer program code, the computer program code comprising computer executable instructions configured for:
a. providing a file share server, the file share server accessible to a plurality of users over a computer network, the file share server associating a plurality of files to a real-world event;
b. connecting to a plurality of users and receiving files from users in the plurality;
c. determining a passcode related to a real world event;
d. storing files that meet a requirement for time and place; and
e. sending stored files to users in the plurality.

19. The medium of claim 18, wherein files are stored for a predetermined time duration determined by a user and received by the file share server at the time the file is uploaded to the file share server.

20. The medium of claim 18, wherein files are stored for a predetermined time duration determined for all files related to a particular event.
